(19) United States
(12) Patent Application Publication
(10) Pub. No.: US 2022/0098021 A1
(43) Pub. Date: Mar. 31, 2022

(54) MULTIVALVE DISPENSER

(71) Applicant: The Coca-Cola Company, Atlanta, GA (US)

(72) Inventors: David SLAGLEY, Roswell, GA (US); Doug McDOUGALL, Decatur, GA (US)

(21) Appl. No.: 17/426,715

(22) PCT Filed: Jan. 31, 2020
(86) PCT No.: PCT/US2020/016128

§ 371 Date: Jul. 29, 2021

Related U.S. Application Data
(60) Provisional application No. 62/800,001, filed on Feb. 1, 2019.

(51) Int. Cl. B67D 1/00; B67D 1/12

(52) U.S. Cl. CPC B67D 1/0036; B67D 1/0085; B67D 2001/0094; B67D 1/1277

(57) ABSTRACT

The present application provides a beverage dispensing system. The beverage dispensing system may include a first valve connected to a rigid form by way of a first tube positioned through a valve cover and a second valve connected to a second tube positioned through the valve cover and exiting the valve cover without being in connection with the rigid form.

### TECHNICAL FIELD

The present technology relates to delivery of fluids through a dispenser. More specifically, the present technology relates to a multivalve dispensers transporting fluids in beverage dispensers.

### BACKGROUND

Beverage dispensers come in a variety of shapes and sizes and the support equipment components are no different. Beverage dispensers contain one or more syrup pumps that can be configured in different ways in order to best utilize the available space. For example, syrup pumps can be mounted sideways to use less horizontal space and can be in a single row/column or multiple rows/columns.

Traditional beverage dispensers include two fluid paths, namely one fluid path for water and a second fluid path for syrup. More recently, multivalve dispensers can have as many as four fluid paths, including one water path and three different fluid paths for syrups allowing different beverages to be accessible from one dispenser.

Multivalve dispensers (rigid connectors)—However, multivalve dispensers include rigid valves and connectors, which do not allow flexibility, and can, depending on the configuration of the dispenser prevent usage of one or more valves due to obstruction of the fluid path associated with the dispenser valve. A conventional multivalve dispenser is illustrated in FIGS. 1A-1C.

FIG. 1A illustrates a conventional multivalve dispenser system 100 having four valves 110, 120, 130, 140. In conventional dispensers the valve is rigid and not configured to adjust or otherwise move once attached to a valve cover 150. The valve cover, also referred to as a back block, is used to secure (e.g., mount) the valve within the dispenser system. In some instances, the valve cover includes a manual “on/off” positions.

Each of the valves 110-140 include tubing that is intended to connect a casing 160. However, in conventional systems, one or more of the valves may be non-operational (e.g., bottom right valve 140 as shown in FIGS. 1A-1C), designated with an “X” because the valve tube 145 is not in connection with the casing 160 due to the rigid configuration of the valve and/or predetermined configuration of the casing 160.

It is understood by one of skill in the art that any of the dispenser valves 110-140 could be non-operational based to the configuration of the dispenser 100. For example, upper left valve 110 could be designated as non-functional where the casing 160 and/or rigid form 170 obstruct the tube associated with valve 110.

FIG. 1B illustrates a right side view of the system 100 that houses a rigid form 170. The valve 140 connects to the rigid form 170 connects to a tubing 125 that connects to the rigid form 170. However, as illustrated, the valve 140 connects to a tubing 145, separate and distinct from the tubing 125, and the tubing 145 does not connect to the casing 160 or rigid form 170 due to the predetermined configuration of the casing 160 and/or rigid form 170.

FIG. 1C illustrates a bottom view of the system 100 additionally showing that the tubing 145 connected to the valve 140 is not connected to the casing 160 or rigid form.

Tubes of conventional multivalve dispensers, as illustrated in FIGS. 1A-C are typically intended to follow a generally straight path through the valve cover, also known as a back block, (e.g., 150) and are typically inflexible.

FIG. 1D shows two of the dispenser valves 110-140 in the valve cover 150 in communication with a nozzle. The valves 100-140 may be operated in response to an actuation valve.

### SUMMARY

The multivalve dispenser of the present technology is intended provide tubing intended to follow a path that allows it pass through a valve cover and reach a rigid form in a steel case. In many embodiments, at least one of the tubes connected to the valve is configured to flex and adjust to one or more configurations that allow passage through the predetermined configuration of a casing and/or rigid form.

The present technology provides multivalve dispensers having fixed or rigid valve component(s), sometimes referred to as hard plumb dispensers, the ability to utilize all dispenser valves. The present technology can additionally be used on multivalve dispensers having flexible valve components in order to utilize all dispenser valves.

### DESCRIPTION OF THE DRAWINGS

FIG. 1A illustrates a front view of a conventional multivalve dispenser system where one of the valves is non-functional due to an obstruction.

FIG. 1B illustrates a right side view of the multivalve system of FIG. 1A.

FIG. 1C illustrates a bottom view of the multivalve system of FIG. 1A.

FIG. 1D illustrates a schematic of the conventional multivalve dispenser.

FIG. 2A illustrates a first embodiment of a multivalve dispenser system where each of the valves is functional.

FIG. 2B illustrates a right side view of the multivalve system of FIG. 2A.

FIG. 2C illustrates a bottom of the multivalve system of FIG. 2A.

FIG. 3 illustrates a right side view of a second embodiment of a multivalve dispenser system where each of the valves is functional.

FIG. 4 illustrates a right side view of another embodiment of a multivalve dispenser system where each of the valves is functional.

FIG. 5 illustrates a right side view of another embodiment of a multivalve dispenser system where each of the valves is functional.

FIG. 6 illustrates a schematic of the multivalve dispenser of the present invention.

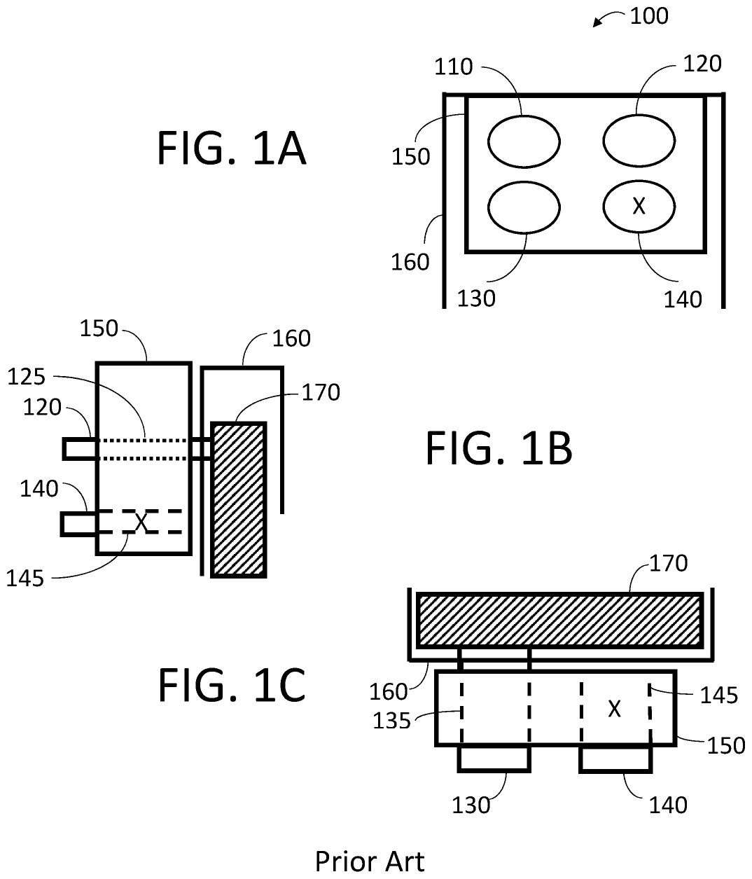

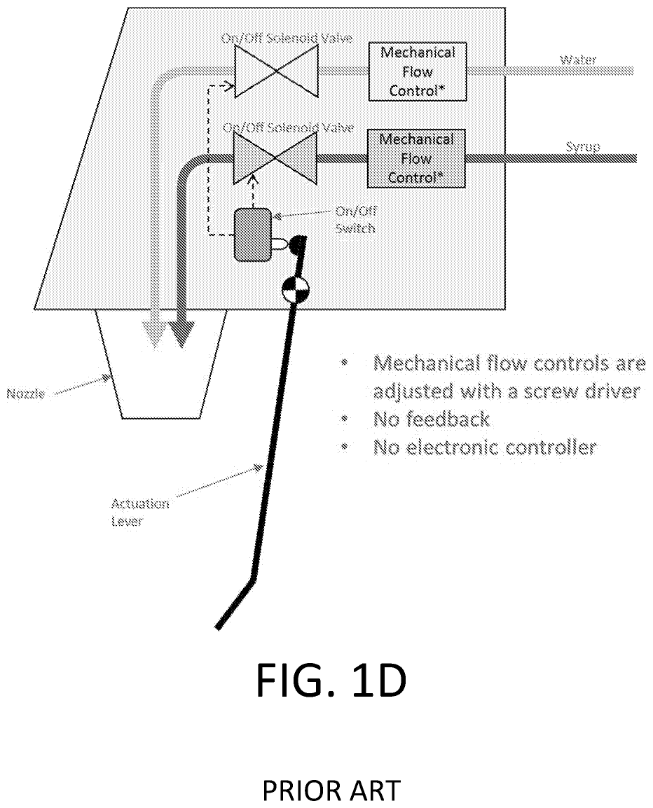

The drawings show example implementations of the present technology, and the invention is not necessarily limited to the embodiments illustrated expressly.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components described herein in connection with one or more functions are to be interpreted to cover embodiments in which a single component performs the function(s).

In some instances, well-known components, systems, materials, or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

While the present technology is described primarily in connection with beverage dispensers, it is contemplated that the technology can be applied to various fluid mixing and distribution scenarios. In additional to the embodiments described herein, other embodiments are contemplated.

### System Overview

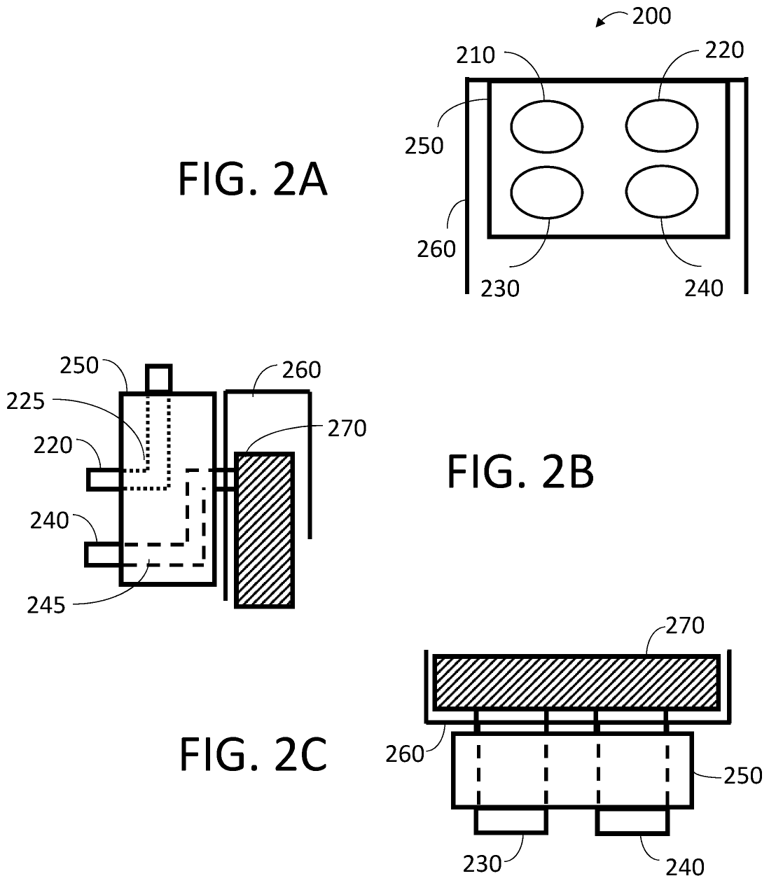

FIG. 2A illustrates an embodiment of a multivalve dispenser system 200 having four valves 210, 220, 230, 240. Each of the valves 210-240 include tubing that connects to a casing 260.

FIG. 2B illustrates a right side view of the system 200 that houses a rigid form 270, and FIG. 2C illustrates a bottom view of the system 200. Unlike in conventional systems, each of the valves 210-240 of the dispensing system 200 is intended to be operational. For example, as illustrated, the valve 240 connects to a tubing 245 that connects to the rigid form 270.

In some embodiments, one or more of the valves 210-240 are allowed to adjust by connecting to a flexible tubing that allows the tubing to connect to the casing 260 and/or rigid form 270 despite the predetermined configuration of conventional systems (e.g., casing 160 and/or rigid form 170).

### Exemplary Embodiments

In some adjustable embodiments, as illustrated in FIG. 2B, at least one valve 220 connects to a tube 225 at a front surface of a valve cover 250. The valve cover 250, can be referred to by other naming conventions such as mount and back block. In some embodiments, the valve cover 250 includes a manual valve that provides and on/off position. In some embodiments, the tube 225 travels along a path and exits from a top surface of the valve cover 250. In doing so, the valve 220 and the tube 225 may be connected to a separate fluid source such as an additional syrup source.

The valve 240 is configured to connect to the rigid form 270 by way of a tube 245 that provides a separate fluid flow path from tube 225. As illustrated, the tube 245 connects to the valve 240 at the front surface of the valve cover 250 and exits from a back surface of the valve cover 250 where it connects to the predetermined configuration of the case 260 and/or rigid form 270. Because the tube 225 exits from the top surface, the bottom right valve 240 is able to adjust to connect to the rigid form at a location that is predetermined position, unlike conventional systems.

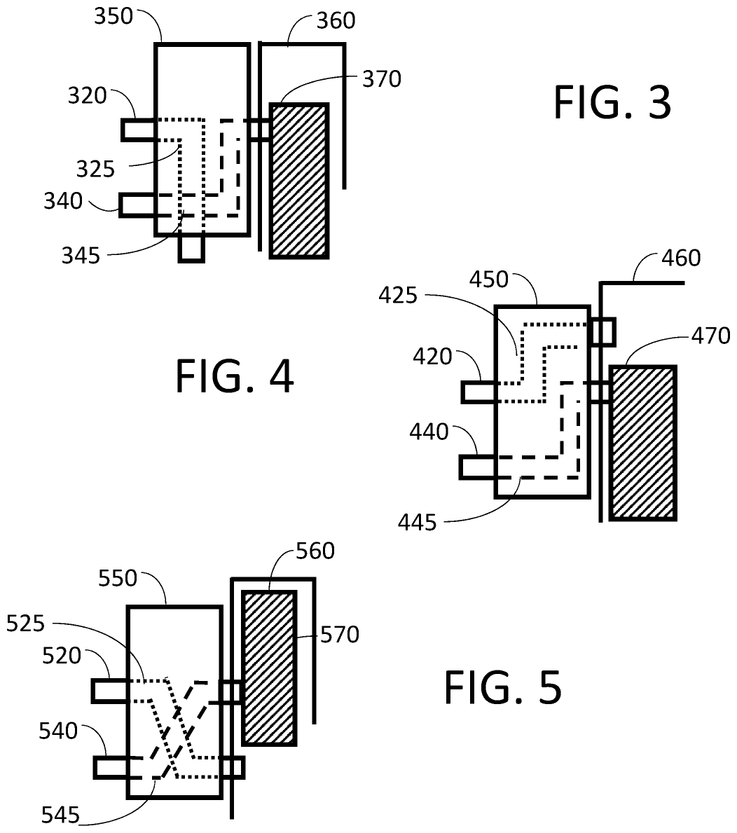

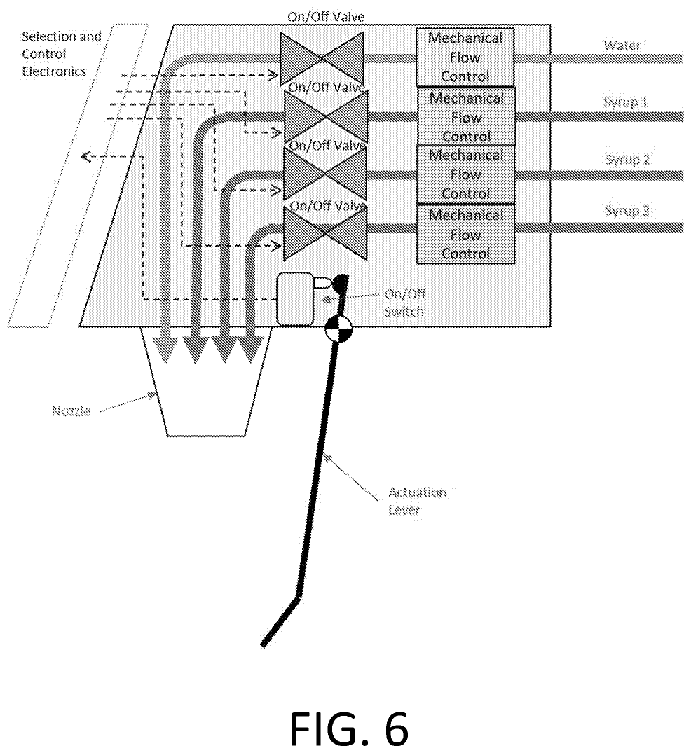

In other embodiments, as illustrated in FIG. 3, a tube 325 travels along a path and exits from a bottom surface of a valve cover 350. For example, tubes 325 and 345 pass one another to maintain separation of the fluid flows within the tubes 325, 345. In embodiments, such as in FIGS. 2A-C and FIG. 3, it is additionally contemplated that the tube 225, 325 may exit from a surface that on the valve cover 250, 350 that is not approximate or adjacent the rigid form 2700, 370. For example, the tube 325 exits from a side surface (not illustrated).

In some embodiments, a valve tube enters the valve cover at a one elevation and exits the valve cover at a different elevation. For example, as illustrated in FIG. 4, a first tube 445 enters the valve cover 450 at a front surface at a first elevation and exits a back surface of the valve cover 450 at a second elevation that is lower than the first elevation. Similarly, a second tube 425 enters the front surface at one elevation and exits a back surface of the valve cover 450 at another elevation that is lower than elevation at which the tube 425 entered the front surface.

As illustrated in FIG. 4, tubes 425 enters at a first elevation and exits at a second, lower elevation. Tube 445 is positioned below tube 425, and thus the tube 445 enters the valve cover 450 at an elevation that is lower than that of the entry position of the tube 425 and exits at an elevation that is lower than the exit position of the tube 425.

As illustrated in FIG. 5, a first tube 525 enters at a first elevation and exits at a second, lower elevation. The second tube 545 enters the valve cover 550 at an elevation lower than the first elevation of the tube 525, and exits the valve cover at an elevation higher than the second elevation of the tube 525. Specifically, the tube 525 enters the valve cover 550 at an elevation that is higher than that of the entry position of the tube 545 and exits at an elevation that is lower than the exit position of the tube 445. As such, the tube 545 enters the valve cover 550 at an elevation lower than that of the entry position of tube 525 and exits at an elevation that is higher than the exit position of the tuber 425.

In some embodiments, entry elevation or exit elevation of the tubes is different. In other embodiments, the entry elevation and exit elevation of the tubes may be the same. For example, as illustrated in FIG. 4, exit elevation of tube 445 is the same as the entry elevation of tube 425. In another example, as illustrated in FIG. 5, the exit elevation of tube 525 is the same as the entry elevation of tube 545, and the exit elevation of tube 545 is the same as the entry elevation of tube 525.

In some embodiments, the tubes 425, 445, 525, 545 may transition from one elevation to another (e.g., from a first elevation to a second elevation) at an angle that is suitable to allow each tube 425, 445, 525, 545 to be positioned proximate one another within the dimensional confines of the valve cover 450, 550.

For example, as illustrated in FIG. 4, the tubes 425, 445 transition from one elevation to another using one or more 90 degree angle transition locations. In some embodiments, the tubes may include more than two transition locations depending on the dimensions (e.g., spatial depth) of the valve cover. As illustrated in FIG. 4, the tubes 425, 445 each include two valve transition locations, each being 90 degrees. However, the tubes could include more than two transitions, for example where the valve cover has small dimensions (e.g., smaller depth). In some embodiments, the transition location can have the same angle. In some embodiments, the transition location has different angles.

As another example, as illustrated in FIG. 5, the tubes 525, 545 the angle is formed between 20 degrees and 90 degrees, depending on the dimensions of the valve cover 550. In a specific embodiment, the tubes 525, 545 form a 45 degree angle to transition from the entry position to the exit position.

In some embodiments the tube are positioned, at least in some locations, parallel to one another one another. For example, FIG. 4 illustrates the tubes 425, 445 are positioned parallel to one another from the entry position of the valve cover 450 to the exit position. In some embodiments, the tubes 425, 445 are not be parallel at all locations along the tube from the entry position to the exit position.

In some embodiments, the fluid paths are not positioned parallel to one another. For example, FIG. 5 illustrates the tubes 525, 545 transition from an elevation at the entry point of valve cover 550 to an elevation at the exit point that causes tubes 525, 545 to not be parallel. In such embodiment, the tubes 525, 545 may be positioned such that one tube is in front of another. For example, the tube 525 may be positioned in front of the tube 545, thus allowing the tube 525 to transition from the entry point to the exit point without interference of the tube 545.

### Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface may be referenced, for example, the referenced surface can, but need not be, vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A beverage dispensing system, comprising:
a first valve connected to a rigid form by way of a first tube positioned through a valve cover; and
a second valve connected to a second tube positioned through the valve cover, and exiting the valve cover without being in connection with the rigid form.

2. The dispensing system of claim 1, wherein the second tube is positioned to enter the valve cover at a front surface and exit the valve cover at a top surface.

3. The dispensing system of claim 1, wherein the second tube is positioned to enter the valve cover at a front surface and exit the valve cover at a bottom surface.

4. The dispensing system of claim 1, wherein:
the first tube is positioned to enter the valve cover at a front surface at a first elevation, and exit the valve cover at back surface at a second elevation; and
the second tube is positioned to enter the valve cover at a front surface at a third elevation, above the first elevation, and exit the valve cover at the back surface at a fourth elevation, above the second elevation.

5. The dispensing system of claim 1, wherein:
the first tube is positioned to enter the valve cover at a front surface at a first elevation, and exit the valve cover at back surface at a second elevation, above the first elevation; and
the second tube is positioned to enter the valve cover at a front surface at a third elevation, above the first elevation, and exit the valve cover at the back surface at a fourth elevation, below the second elevation.

6. The dispensing system of claim 1, further comprising a third valve connected to a third tube.

7. The dispensing system of claim 6, further comprising a fourth valve connected to a fourth tube.

8. The dispensing system of claim 1, wherein the first valve and the second valve comprise syrup valves.

9. The dispensing system of claim 1, wherein the first valve comprises a water valve.

10. The dispensing system of claim 1, wherein the first valve and the second value are in communication with a nozzle.

11. The dispensing system of claim 1, wherein the first valve and the second valve are operated by an actuation lever.

12. The dispensing system of claim 1, wherein the rigid form is positioned within a casing.

13. The dispensing system of claim 1, wherein the first tube and the second tube comprise flexible tubes.

14. The dispensing system of claim 1, wherein the first valve and the second valve comprises on/off valves.
